(19) United States
(12) Patent Application Publication
(10) Pub. No.: US 2004/0047694 A1
(43) Pub. Date: Mar. 11, 2004

(54) Polymer-modified earth building materials

(76) Inventors: Mario Sandor, Obrigheim (DE); Stefan Dreher, Neustadt (DE); Joachim Pakusch, Speyer (DE); Hans-Jurgen Denu, Friedelsheim (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/450,657

(22) PCT Filed: Dec. 14, 2001
(86) PCT No.: PCT/EP01/14740

(30) Foreign Application Priority Data
Dec. 15, 2000 (DE) 100 62 657.2

(51) Int. Cl. E02D 3/12; C09K 17/00

(52) U.S. Cl. 405/263; 405/264

(57) ABSTRACT

The invention relates to polymer-modified earthwork materials, containing a) a mineral main constituent based on sand, grit and/or gravel and b) at least one hydrophobic synthetic polymer that is uniformly distributed in the mineral main constituent. The invention also relates to a method for the production of said materials and to a method for the fortification of earth.

### SPECIFICATION

The present invention relates to earth building materials which have been modified with hydrophobic polymers, and also to a process for preparing them and a method of consolidating soils.

Many constructional building operations, such as the building of dams and dikes, the sealing of landfills, pavement base construction, the consolidation of surfaces under mechanical load, such as parking lots or embankments, and so on, continue to be based in part or even predominantly on the use of earth building materials, such as excavated soil in general, particularly silt, sand, gravel, clay, loam or mixtures thereof. The materials in question predominantly comprise clastic sediments, which differ substantially in particle size. The particle size of silt is typically from 0.002 to 0.06 mm, of sand from 0.06 to 2 mm, and of gravel from 2 to 60 mm. In comparison, clay particles typically have a diameter of less than 0.02 mm. The term loam refers to clay, generally with a yellow or brownish coloration due to very fine limonite (brown iron ore) with more or less extensive additions of silt, sand and gravel, possibly including additions of larger rock particles and also organic components.

Disadvantageous features of earth building materials include, frequently, their low level of cohesion and thus their low mechanical strength and formability, and their generally high water perviousness. These qualities result in poor durability and stability of the building operations carried out using such materials, especially under damp conditions. These disadvantages are all the more strongly pronounced the lower the fraction of what are known as binding soils such as clay or loam in the earth building materials. Earth building materials based on sand, gravel and/or chippings, i.e., earth building materials with low fractions of binding soils, are of particular interest for constructional building operations, on grounds of cost. Moreover, they are easier to handle than binding soils and generally do not shrink on drying, or have a shrinkage on drying which is less than that of binding soils.

A variety of attempts have been made to improve the mechanical properties of earth building materials by adding lime, usually in the form of what is known as burnt lime (calcium oxide). In actual fact the addition of lime leads in part to improved cohesion, but generally also results in embrittlement of the earth building material, making it unsuitable for many applications.

It is also known from the literature to enhance the resistance of the surface of soils, dams, dikes and the like to erosion by surface treatment of the respective construction with aqueous polymer formulations. Accordingly, SU-A-179 67 743 describes a binder for increasing the strength, water resistance and erosion stability of sand, consisting of water, ligninsulfonate and tree resin. JP-A-60004587 describes the surface treatment of soils to counter erosion by the sprayed application of dilute (meth)acrylate dispersions. DE-A-195 48 314 describes enhancing the surface strength of soils by applying to their surface an aqueous, tack-increasing formulation comprising polyvinyl acetate and a mixture of monocarboxylic acids.

JP-A-2283792 describes a composition comprising bentonite, loam, sand, a reemulsifiable polymer powder, a water-soluble polymer powder and sodium silicate powder, which is hardened by tamping.

DE 199 21 815 describes the use of aqueous, polysulfide-free polymer formulations as an addition to building materials based on loam or clay. The long-term stability of these building materials is not always satisfactory.

DE 199 62 600 describes sandbags for disaster relief, containing a polymer powder which results in stabilization of the sandbags or of the sandbag walls by sticking together when moisture penetrates the interior of the bags. These sandbags are unsuitable for use as building materials for constructional loading operations.

It is an object of the present invention to provide modified earth building materials, especially modified earth building materials with a high sand and/or gravel fraction, which possess improved cohesion and ductility. The earth building materials are to be suitable for constructional building operations or constructions such as pavement base construction, dam building and dike building, embankments, parking lot consolidation or landfill sealing. Moreover, improved durability and water resistance of these constructions is desired. The earth building materials should be easy and inexpensive to modify and process.

We have found that this object is achieved by earth building materials, especially earth building materials having a high sand and/or gravel fraction, which comprise at least one uniformly distributed water-insoluble addition polymer.

The present invention accordingly provides earth building materials comprising

a) a principal, mineral component based on sand, chippings and/or gravel and

b) at least one film-forming water-insoluble addition polymer which is uniformly distributed in the principal, mineral component.

All quantities relating to the earth building materials refer to their solids content. The solids content of the earth building materials is determined by drying them at 120° C. for 24 hours. All quantities which affect the addition polymer present in accordance with the invention, and any additives and auxiliaries present in the polymer, are calculated as solids, unless indicated otherwise. The solids content of the polymers and of the additives and auxiliaries they may contain are determined by drying them at 120° C. at a constant weight.

Preferred principal, mineral components are sands and gravels. The principal, mineral components may additionally include mineral binders, whose fraction is generally less than 20% by weight, based on 100% by weight of principal, mineral component. Typical mineral binders here are burnt lime, loam and clay. Minor amounts (i.e., up to 2% by weight) of cement are also possible.

The principal, mineral component of the earth building materials of the invention contains preferably less than 20% by weight, in particular less than 15% by weight, of burnt lime (calcium oxide), and less than 20% by weight, in particular less than 10% by weight, of loam and/or clay. In preferred embodiments, the principal, mineral component is substantially free of cement.

In order to ensure that the earth building material has sufficient strength, it is generally necessary for it to include at least 1 part by weight, preferably at least 2 parts by weight, and in particular at least 3 parts by weight, of water-insoluble hydrophobic, film-forming addition polymer, based on 100 parts by weight of mineral components. In general, amounts above 50 parts by weight, based on 100 parts by weight of mineral components, will not be necessary. The earth building material preferably contains not more than 40 parts by weight, in particular not more than 30 parts by weight, and with particular preference not more than 15 parts by weight, of water-insoluble, film-forming addition polymer, based on 100 parts by weight of mineral components.

The water-insoluble, film-forming addition polymers employed are known, are available commercially, or may be prepared in accordance with known methods.

The addition polymers used in accordance with the invention to modify the earth building materials are film-forming. This means that the particles of the film-forming polymer flow together to form a polymeric film at a temperature which is situated below the preparation, processing and/or drying temperature of the modified earth building materials. The temperature above which film formation occurs is also referred to as the minimum film formation temperature (MFFT).

Uniform film formation of the polymer in the earth building materials is generally ensured when the glass transition temperature T_{g} of the polymer is below 80° C., preferably below 50° C., in particular below 30° C., and with particular preference below 25° C. The glass transition temperature referred to here is the midpoint temperature determined in accordance with ASTM D3418-82 by differential thermal analysis (DSC) (see also Zosel, Farbe und Lack 82 (1976), 125-134, and DIN 53765). For sufficient strength of the earth building materials of the invention it is of advantage if the glass transition temperature of the polymer is at least −30° C., preferably at least −20° C. and in particular at least −10° C. or −5° C. With regard to the elasticity it is also advantageous if the glass transition temperature T_{g} does not exceed a level of 50° C., in particular 30° C. The glass transition temperature of polymers constructed from ethylenically unsaturated monomers may be controlled, familiarly, by way of the monomer composition (T. G. Fox, Bull. Am. Phys. Soc. (Ser. II) 1, 123 [1956] and Ullmann's Encyclopedia of Industrial Chemistry 5^{th} Ed., Vol. A21, Weinheim (1989) p. 169).

In preferred embodiments of the present invention, the glass transition temperature Tg of the polymer is situated in the range from −20° C. to +25° C., preferably from −10° C. to +20° C., and in particular from −5° C. to +15° C. Glass transition temperatures within this range are advantageous on account of the fact that they permit effective filming of the polymer and thus advantageous mechanical properties of the earth building materials of the invention without said materials having to be dried or consolidated at elevated temperatures, or even “burnt”.

In accordance with the invention the polymer used is hydrophobic. Polymers of this kind are characteristically insoluble in water and have polymer films which exhibit only a low level of water absorption, i.e., less than 40 g/100 g polymer film, in particular below 30 g/100 g polymer film.

Examples of such hydrophobic polymers are homopolymers or copolymers of (meth)acrylates, copolymers of at least one (meth)acrylate and at least one vinylaromatic, e.g., styrene, copolymers of olefins and/or diolefins and vinylaromatics, e.g., of butadiene and styrene, or copolymers of vinyl esters and olefins, e.g., vinyl acetate and ethylene.

Prefferred hydrophobic polymers are constructed from ethylenically unsaturated monomers M, which generally include at least 80% by weight, in particular at least 90% by weight, of ethylenically unsaturated monomers A having a water solubility <60 g/l and in particular <30 g/l (25° C. and 1 bar), it being possible for up to 30% by weight, e.g., from 5 to 25% by weight, of monomers A to be replaced by acrylonitrile and/or methacrylonitrile. In addition, the monomers A further include 0.5 to 20% by weight of monomers B, which are different than monomers A. Here and below, all quantities for monomers in % by weight are based on 100% by weight of monomers M.

Monomers A are generally monoethylenically unsaturated or are conjugated diolefins. Examples of monomers A are:

esters of α,β-ethylenically unsaturated C₃-C₆ monocarboxylic acid or C₄-C₈ dicarboxylic acid with a C₁-C₁₀ alkanol. These are preferably esters of acrylic acid or methacrylic acid, such as methyl (meth)acrylate, ethyl (meth)acrylate, n-butyl (meth)acrylate, t-butyl (meth)acrylate, 2-ethylhexyl (meth)acrylate etc.;

vinylaromatic compounds, such as styrene, 4-chlorostyrene, 2-methylstyrene, etc.;

vinyl esters of aliphatic carboxylic acids having preferably from 1 to 10 carbon atoms, such as vinyl acetate, vinyl propionate, vinyl laurate, vinyl stearate, Versatic acid vinyl esters, etc.;

olefins, such as ethylene or propylene;

conjugated diolefins, such as butadiene or isoprene;

vinyl chloride or vinylidene chloride.

Preferred film-forming polymers are selected from the polymer classes I to IV set out below:

I) copolymers containing in copolymerized form, as monomer A, styrene and at least one C₁-C₁₀ alkyl ester of acrylic acid and, if desired, one or more C₁-C₁₀ alkyl esters of methacrylic acid;

II) copolymers containing in copolymerized form, as monomer A, styrene and at least one conjugated diene and, if desired, (meth)acrylic esters of C₁-C₈ alkanols, acrylonitrile and/or methacrylonitrile;

III) copolymers containing in copolymerized form, as monomer A, methyl acrylate, at least one C₁-C₁₀ alkyl ester of acrylic acid and, if desired, a C₂-C₁₀ alkyl ester of methacrylic acid;

IV) copolymers containing in copolymerized form, as monomer A, at least one vinyl ester of an aliphatic carboxylic acid having from 2 to 10 carbon atoms and at least one C₂-C₆ olefin and also, if desired, one or more C₁-C₁₀ alkyl esters of acrylic acid and/or of methacrylic acid.

Typical C₁-C₁₀-alkyl esters of acrylic acid in the copolymers of classes I to IV are ethyl acrylate, n-butyl acrylate, tert-butyl acrylate, n-hexyl acrylate and 2-ethylhexyl acrylate.

Typical copolymers of class I contain as monomers A from 20 to 80% by weight and in particular from 30 to 70% by weight of styrene and from 20 to 80% by weight, in particular from 30 to 70% by weight, of at least one C₁-C₁₀ alkyl ester of acrylic acid such as n-butyl acrylate, ethyl acrylate or 2-ethylhexyl acrylate, based in each case on the overall amount of the monomers A.

Typical copolymers of class II contain as monomers A, based in each case on the overall amount of the monomers A, from 30 to 85% by weight, preferably from 40 to 80% by weight, and with particular preference from 50 to 75% by weight, of styrene and from 15 to 70% by weight, preferably from 20 to 60% by weight, and with particular preference from 25 to 50% by weight, of butadiene, it being possible for from 5 to 20% by weight of the aforementioned monomers A to be replaced by (meth)acrylic esters of C₁-C₈-alkanols and/or by acrylonitrile or methacrylonitrile.

Typical copolymers of class III contain in copolymerized form, as monomers A, based in each case on the overall amount of monomers A, from 20 to 80% by weight, preferably from 30 to 70% by weight, of methyl methacrylate and at least one further monomer, preferably one or two further monomers, selected from acrylic esters of C₁-C₁₀ alkanols, especially n-butyl acrylate, 2-ethylhexyl acrylate and ethyl acrylate, and, if desired, a methacrylic ester of a C₂-C₁₀ alkanol, in an overall amount of from 20 to 80% by weight and preferably from 30 to 70% by weight.

Typical copolymers of class IV contain in copolymerized form, as monomers A, based in each case on the overall amount of the monomers A, from 30 to 90% by weight, preferably from 40 to 80% by weight, and with particular preference from 50 to 75% by weight, of a vinyl ester of an aliphatic carboxylic acid, especially vinyl acetate, and from 10 to 70% by weight, preferably from 20 to 60% by weight, and with particular preference from 25 to 50% by weight, of C₂-C₆ olefin, especially ethylene, and, if desired, one or two further monomers, selected from (meth)acrylic esters of C₁-C₁₀ alkanols, in an amount of from 1 to 15% by weight.

Among the abovementioned polymers, the polymers of classes I and II are particularly suitable.

Suitable monomers B include in principle all monomers which differ from the abovementioned monomers and are copolymerizable with the monomers A. Such monomers are known to the skilled worker and generally serve to modify the properties of the polymer.

Preferred monomers B are selected from monoethylenically unsaturated monocarboxylic and dicarboxylic acids having from 3 to 8 carbon atoms, especially acrylic acid, methacrylic acid, itaconic acid, their amides such as acrylamide and methacrylamide, their N-alkylolamides such as N-methylolacrylamide and N-methylolmethacrylamide, their hydroxy-C₁-C₄ alkyl esters such as 2-hydroxyethyl acrylate, 2- and 3-hydroxypropyl acrylate, 4-hydroxybutyl acrylate, 2-hydroxyethyl methacrylate, 2- and 3-hydroxypropyl methacrylate, 4-hydroxybutyl methacrylate, and monoethylenically unsaturated monomers containing oligoalkylene oxide chains, preferably with polyethylene oxide chains having degrees of oligomerization preferably in the range from 2 to 200, e.g., monovinyl ethers and monoallyl ethers of oligoethylene glycols, and also esters of acrylic acid, of maleic acid or of methacrylic acid with oligoethylene glycols.

The fraction of the monomers containing acid groups is preferably not more than 10% by weight and in particular not more than 5% by weight, e.g., from 0.1 to 5% by weight, based on the monomers M. The fraction of hydroxyalkyl esters and monomers containing oligoalkylene oxide chains, where present, is preferably in the range from 0.1 to 20% by weight and in particular in the range from 1 to 10% by weight, based on the monomers M. The fraction of the amides and N-alkylol amides, where present, is preferably in the range from 0.1 to 5% by weight.

Besides the abovementioned monomers B, further suitable monomers B include crosslinking monomers, such as glycidyl ethers and glycidyl esters, examples being vinyl, allyl and methallyl glycidyl ethers, glycidyl acrylate and glycidyl methacrylate, the diacetonylamides of the abovementioned ethylenically unsaturated carboxylic acids, e.g., diacetone(meth)acrylamide, and the esters of acetyl acetic acid with the abovementioned hydroxyl alkyl esters of ethylenically unsaturated carboxylic acids, e.g., acetyl acetoxy ethyl (meth)acrylate. Further suitable monomers B include compounds containing two nonconjugated, ethylenically unsaturated bonds, examples being the diesters and oligoesters of polyhydric alcohols with α,β-monoethylenically unsaturated C₃-C₁₀ monocarboxylic acids, such as alkylene glycol diacrylates and dimethacrylates, e.g. ethylene glycol diacrylate, 1,3-butylene glycol diacrylate, 1,4-butylene glycol diacrylate, propylene glycol diacrylate, and also divinylbenzene, vinyl methacrylate, vinyl acrylate, allyl methacrylate, allyl acrylate, diallyl maleate, diallyl fumarate, methylenebisacrylamide, cyclopentadienyl acrylate, tricyclodecenyl (meth)acrylate, N,N′-divinylimidazolin-2-one or triallyl cyanurate. Further suitable monomers B include vinylsilanes, examples being vinyltrialkoxysilanes.

In order to achieve uniform distribution of the polymer in the earth building material it has been found appropriate to use the polymer in the form of finely divided particles. By finely divided polymers are meant those whose weight-average particle diameter, d₅₀, does not exceed 10 μm and in particular does not exceed 2 μm. The weight-average particle diameter, d₅₀, of the polymer particles is situated in particular in the range from 100 to 2000 nm. By the weight-average particle diameter d₅₀ is meant the particle diameter below which 50% by weight of the polymer particles fall. The weight-average particle diameter of polymer may be determined, familiarly, by quasielastic light scattering or ultracentrifuged measurements on an aqueous dispersion of the particles.

Polymers having such particle diameters are generally in the form of aqueous dispersions or in the form of powders obtainable from said dispersions by evaporating off the water. For the preparation of the earth building materials of the invention, therefore, preference is given to polymers in the form of aqueous polymer dispersions, especially those obtainable by free-radical aqueous emulsion polymerization of the above-mentioned ethylenically unsaturated monomers. Preference is likewise given to polymer powders prepared from them, and to aqueous dispersions obtainable by redispersing the polymer powders in water. Very particularly preferred polymers are redispersible polymer powders, especially redispersible polymer powders obtainable from an aqueous dispersion. Processes for preparing aqueous polymer dispersions and for preparing polymer powders from aqueous polymer dispersions are described in large numbers in the prior art (see, for example, D. Distler, Wässrige Polymerdispersionen, Wiley VCH, Weinheim 1999; H. Warson, Synthetic Resin Emulsions, Ernest Benn Ltd., London 1972, pp. 193-242; on the preparation of polymer powders, see also WO 98/03577 and WO 98/03576, whose disclosed content is hereby incorporated by reference). Moreover, both aqueous polymer dispersions and the powders prepared from them are available commercially, for example, under the ACRONAL®-STYRONAL®-, BUTOFAN®- and STYROFAN®- brandnames of BASF-Aktiengesellschaft, Ludwigshafen, Germany.

Advantageous properties in the earth building materials of the invention are displayed in particular, as described above, by redispersible polymer powders which have been prepared using naphthalenesulfonic acid-formaldehyde condensates as auxiliary system for the drying operation. Such polymer powders are obtained, for example, by the freeze drying, and with particular preference by the spray drying, of polymer dispersions. Preferred drying assistants are the alkali metal and alkaline earth metal salts of naphthalenesulfonic acid-formaldehyde condensation products that are described in WO 98/03577, hereby incorporated by reference.

The free-radical aqueous emulsion polymerization of the monomers M takes place in the presence of at least one surface-active substance and at least one, preferably water-soluble, initiator of the free-radical polymerization, at temperatures preferably in the range from 20 to 120°C.

Suitable initiators include azo compounds, organic or inorganic peroxides, salts of peroxodisulfuric acid, and redox initiator systems. Preference is given to using a salt of peroxodisulfuric acid, especially a sodium, potassium or ammonium salt, or a redox initiator system comprising as oxidant hydrogen peroxide or an organic peroxide such as tert-butyl hydroperoxide and as reductant a sulfur compound, selected in particular from sodium hydrogen sulfite, sodium hydroxymethanesulfinate, and the hydrogen sulfite adduct of acetone.

Suitable surface-active substances include the protective colloids and emulsifiers that are commonly used for emulsion polymerization. Preferred emulsifiers are anionic and nonionic emulsifiers, which unlike the protective colloids generally have a molecular weight below 2000 g/mol and are used in amounts of up to 0.2 to 10% by weight, preferably from 0.5 to 5% by weight, based on the polymer in the dispersion or on the monomers M to be polymerized.

The anionic emulsifiers include alkali metal salts and ammonium salts of alkyl sulfates (alkyl: C₈-C₂₀), of sulfuric monoesters with ethoxylated alkanols (EO units: 2 to 50, alkyl: C₈ to C₂₀) and with ethoxylated alkylphenols (EO units: 3 to 50, alkyl: C₄-C₂₀), of alkylsulfonic acids (alkyl: C₈ to C₂₀) and of alkylarylsulfonic acids (alkyl: C₄-C₂₀). Further suitable anionic emulsifiers can be found in Houben-Weyl, Methoden der organischen Chemie, Volume XIV/1, Makromolekulare Stoffe, Georg-Thieme-Verlag, Stuttgart, 1961, pp. 192-208.

The anionic surface-active substances also include compounds of the formula I,

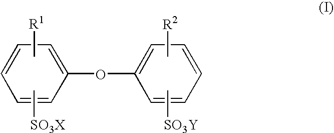

where R¹ and R² are hydrogen or linear or branched alkyl radicals having from 6 to 18 carbon atoms and in particular having 6, 12 and 16 carbon atoms, R¹ and R² not both being simultaneously hydrogen. X and Y are preferably sodium, potassium or ammonium, with sodium being particularly preferred. Use is frequently made of technical-grade mixtures containing a fraction of from 50 to 90% by weight of the monoalkylated product, an example being Dowfax® 2A1 (trademark of Dow Chemical Company). The compounds I are general knowledge, from U.S. Pat. No. 4,269,749, for example.

Suitable nonionic emulsifiers are araliphatic or aliphatic nonionic emulsifiers, examples being ethoxylated mono-, di- and trialkylphenols (EO units: 3 to 50, alkyl: C₄-C₉), ethoxylates of long-chain alcohols (EO units: 3 to 50, alkyl: C₈-C₃₆), and also polyethylene oxide/polypropylene oxide block copolymers. Preference is given to ethoxylated long-chain alkanols (alkyl: C₁O-C₂₂, average degree of ethoxylation: from 3 to 50) and, of these, particular preference to those based on oxo alcohols and naturally occurring alcohols having a linear or branched C₁₂-C₁₈ alkyl radical and a degree of ethoxylation of from 8 to 50.

It is preferred to use anionic emulsifiers, especially emulsifiers of the formula I, or combinations of at least one anionic and one nonionic emulsifier.

In specific embodiments of the present invention it may be advantageous to use polymers which include at least one alkoxylated, preferably ethoxylated, nonionic emulsifier and/or at least one alkoxylated, preferably ethoxylated, anionic emulsifier, for example, one of those mentioned above. Preferably, the amount of these emulsifiers is situated in the range from 0.1 to 3.5% by weight, with particular preference from 0.2 to 3% by weight, based on the overall weight of all copolymerized monomers. The alkoxylated emulsifier or the alkoxylated emulsifiers may be added following the preparation of the polymers, or may, preferably, be used for their preparation. Depending on the nature of the soils used to prepare the earth building materials, such alkoxylated emulsifiers may not only improve the preparability and the processing properties but also increase the mechanical strength and reduce any possible shrinkage on drying or hardening of the earth building materials.

Examples of suitable protective colloids are polyvinyl alcohols, starch derivatives and cellulose derivatives, carboxyl-containing polymers such as homopolymers and copolymers of acrylic acid and/or of methacrylic acid with comonomers such as styrene, olefins or hydroxyalkyl esters, or vinylpyrrolidone homopolymers and copolymers. A comprehensive description of further suitable protective colloids is given in Houben-Weyl, Methoden der organischen Chemie, Volume XIV/1, Makromolekulare Stoffe, Georg-Thieme-Verlag, Stuttgart 1961, pp. 411-420. Mixtures of emulsifiers and/or protective colloids may also be used.

The molecular weight of the polymers may of course be adjusted by adding regulators in a small amount, generally up to 2% by weight, based on the polymerizing monomers M. Particularly suitable regulators include organic thio compounds, and also allyl alcohols and aldehydes. In the preparation of the butadiene-containing polymers of class I it is common to use regulators in an amount of from 0.1 to 2% by weight, preferably organic thio compounds such as tert-dodecyl mercaptan.

The emulsion polymerization may take place either continuously or by the batch process, preferably by a semicontinuous process. The monomers to be polymerized may be supplied continuously, including by a staged or gradient procedure, to the polymerization batch. The monomers may be supplied to the polymerization either as a monomer mixture or as an aqueous monomer emulsion.

Besides the seed-free mode of preparation, it is possible, for the purpose of establishing a defined polymer particle size, to carry out the emulsion polymerization by the seed latex process or in the presence of seed latex prepared in situ. Processes for doing this are known and may be found in the prior art (see EP-B 40419 and also Encyclopedia of Polymer Science and Technology, Vol. 5, John Wiley & Sons Inc., New York 1966, p. 847).

Following the polymerization reaction proper it may be necessary to free the aqueous polymer dispersions of the invention substantially from odorous substances, such as residual monomers and other volatile organic constituents. This may be done in a manner known per se, physically, by distillative removal (in particular by way of steam distillation) or by stripping with an inert gas. Moreover, the level of residual monomers may be lowered chemically, by free-radical postpolymerization, in particular under the action of redox initiator systems, as set out, for example, in DE-A 44 35 423, DE-A 44 19 518, and DE-A 44 35 422. The postpolymerization is preferably conducted with a redox initiator system comprising at least one organic peroxide and one organic sulfite.

After the end of the polymerization the polymer dispersions used, prior to their use in accordance with the invention, are frequently rendered alkaline, preferably being adjusted to pH values in the range from 7 to 10. Neutralization may be effected using ammonia or organic amines, and also preferably hydroxides, such as sodium hydroxide or calcium hydroxide.

To prepare polymer powders, the aqueous polymer dispersions are subjected in a known manner to a drying process, preferably in the presence of customary drying assistants. A preferred drying process is that of spray drying. Where necessary, the drying assistant is used in an amount of from 1 to 30% by weight, preferably from 2 to 20% by weight, based on the polymer content of the dispersion that is to be dried.

The solids content of the polymer dispersion that is to be dried, already containing the drying assistant or assistants, is generally situated in the range from 10 to 60% by weight, preferably in the range from 20 to 55% by weight (calculated in each case as polymer+drying assistant(s), based on the overall weight of the dispersion).

In the case of spray drying, the polymer dispersions that are to be dried are dried in the presence of the drying assistant in a drying tower through which a stream of hot air is passed. The temperature of the hot air stream at the entry of the drying tower is generally from 100 to 200° C., preferably from 110 to 170° C., and at the exit from the tower is from approximately 30 to 100° C., preferably from 50 to 80° C. The polymer dispersion to be dried may be introduced countercurrent to the hot air stream or, preferably, in parallel to the hot air stream. The addition may take place by way of single-fluid or multifluid nozzles or by way of a rotating disk. The polymer powders are separated off in a customary fashion, using cyclones or filter separators, for example.

Suitable drying assistants include all commonly used drying assistants, examples being homopolymers and copolymers of vinylpyrrolidone, homopolymers and copolymers of acrylic acid and/or of methacrylic acid with hydroxyl-bearing monomers, vinylaromatic monomers, olefins and/or (meth)acrylic esters, polyvinyl alcohol and especially arylsulfonic acid-formaldehyde condensation products, and also mixtures thereof. In principle, the drying agents may be added during the drying operation in the form of solutions, examples including aqueous or aqueous-alcoholic solutions, to the polymer dispersion that is to be dried. Preferably, the drying assistant is added to the polymer dispersion prior to drying. The drying agent may be added to the dispersion either as a solid or, preferably, as a solution, for example, as an aqueous-alcoholic solution or, in particular, as an aqueous solution. It is also possible to use some of the appropriate drying assistants during the actual preparation of the aqueous polymer dispersion, as protective colloids (see above). Preferred drying assistants are arylsulfonic acid-formaldehyde condensation products and their salts, preferably the substances described in WO 98/03577.

During the drying operation it is also possible to add an anticaking agent to the polymer dispersion that is to be dried. This anticaking agent is a finely divided inorganic oxide, such as a finely divided silica or a finely divided silicate, e.g. talc. The finely divided inorganic oxide preferably has an average particle size in the range from 0.01 to 0.5 μm. Particular preference is given to finely divided silica having an average particle size in the range from 0.01 to 0.5 μm, which may either be hydrophilic or have been hydrophobicized. The anticaking agent may be added to the polymer dispersion before or during drying. In another embodiment, the anticaking agent is added to the polymer powder in a mixing apparatus suitable for solids, such as a shaker, roller bed screw mixer or the like.

Where desired, the anticaking agent is used in an amount of from 0.5 to 15% by weight and preferably in an amount of from 2 to 12% by weight, based on the polymer powder (or on the sum of polymer P+drying assistant(s) in the aqueous polymer dispersion).

If desired, the earth building materials of the invention may include minor amounts of further polymers, different from those mentioned above, examples being hydrophobic natural polymers and/or hydrophilic synthetic polymers, such as water-soluble polymers, and what are known as superabsorbent polymers or superabsorbents. The fraction of such polymers, however, is generally below 5% by weight, based on the amount of mineral components, preferably below 2% by weight. In preferred embodiments of the present invention the earth building materials are free or substantially free from such polymers different than the hydrophobic synthetic polymers.

The earth building materials of the invention typically comprise

a) a principal, mineral component comprising

from 50 to 100 parts by weight, preferably from 70 to 100 parts by weight, with particular preference from 80 to 100 parts by weight, of sand, chippings and/or gravel,

from 0 to 20 parts by weight, preferably from 0 to 10 parts by weight, of cement, clay, loam and/or lime,

from 0 to 30 parts by weight of other natural organic and/or mineral earth components,

b) from 1 to 50 parts by weight, preferably from 2 to 40 parts by weight, with very particular preference from 3 to 30 parts by weight, based in each case on 100 parts by weight of principal, mineral components, of at least one water-insoluble, film-forming addition polymer,

c) from 0 to 30 parts by weight, preferably from 1 to 20 parts by weight, and with particular preference from 2 to 15 parts by weight, of water.

By other natural organic and/or mineral earth components are meant in particular organic materials other than the abovementioned earth constituents, such as plant residues, humus, grass, straw, small pieces of wood, residues of wood and/or cork, and inorganic materials, such as silt, expanded slate, perlite and/or expanded clay.

The earth building materials of the invention are generally prepared by simple mixing of soils, earths, sand and/or gravel, which constitute or comprise the principal, mineral components, with the polymer, preferably either in the form of polymer dispersion, or with particular preference, in the form of a polymer powder. Advantageously, mixing is carried on until the polymer is uniformly, or substantially uniformly, distributed in the earth building material. Uniform distribution here means that there are very few local concentration islands of polymer or earth components and in particular that there is no marked concentration gradient in any spatial direction of the earth building material.

It is advantageous for effective filming of the polymer in the earth building materials if the water content of the polymer-modified earth building material before drying, hardening or consolidation is situated in the range from 1% by weight to 30% by weight, preferably from 2% by weight to 20% by weight, and in particular from 3 to 15% by weight, for example about 5% by weight, about 7% by weight or about 10% by weight. The water content in the polymer-modified earth building materials may be adjusted to these levels if desired by adjusting the water content of one or more of the components, i.e., by drying or adding water. The adjustment of the water content in the polymer-modified earth building materials may be done before the mixing of the components, during the mixing of the components, and after the mixing of the components, preferably before or during mixing.

The drying, hardening or consolidation of the earth building materials of the invention takes place generally by leaving the materials in air or by heating them to a temperature of up to 150° C., preferably up to 120° C. At temperatures below 10° C., the drying process generally is undesirably slow. In many cases, drying is carried out, for reasons of cost, in the region of room temperature (15 to 30° C.).

The present invention therefore additionally provides a process for preparing the earth building materials of the invention, which comprises mixing

i) mineral components

ii) at least one water-insoluble addition polymer, and

iii) if desired, water and further components

to a plastically deformable, flowable or free-flowing composition in which the addition polymer is present in uniform distribution.

The composition thus obtained is generally either formable or flowable and can be put directly to the desired use. The composition may also, if desired, be compacted while still wet.

Typical fields of application for the earth building materials of the invention are in constructional building operations, examples being the consolidation of pavement base courses, use in dam building and dike building, use in landfill sealing or in the sealing and consolidation of areas exposed to mechanical loads, such as embankments or parking lots.

The present invention therefore also provides a method of consolidating soils, in which the soil to be consolidated is excavated, the soil thus obtained is reduced in size, if appropriate, at least one hydrophobic addition polymer is added and is mixed in until the polymer is uniformly distributed in the excavated material, mixing being accompanied, where appropriate, by adjustment of the water content of the mixture to a level in the range from 1 to 30% by weight, preferably from 2 to 20% by weight, and in particular from 3 to 15% by weight, and the resulting mixture, i.e., the earth building material of the invention, is reapplied. The method described above is suitable in particular for dam building and dike building, landfill sealing, and, generally, for preventing or retarding unwanted erosion.

The earth building materials of the invention may if desired be processed into shaped bodies, especially building blocks or earth bricks. Suitable processes for producing shaped bodies from mineral compositions such as the earth building materials of the invention are known to the skilled worker.

The consolidated and/or hardened earth building materials of the invention are notable for significantly increased strengths under bending tension and compression, and for increased elasticities in comparison to unmodified shaped clay bodies. The shrinkage commonly observed during the drying of moist compositions based on plastic sediments is generally unaffected, or not significantly deleteriously affected, in the case of the earth building materials of the invention, with the shrinkage usually occurring with retention of dimensions and therefore being of minor importance for the building projects undertaken using the earth building materials of the invention.

The examples which follow are intended to illustrate the invention, but should not be understood as restricting it.

Materials used.

Addition polymer P1

Copolymer of 63 parts by weight of styrene and 32 parts by weight of butadiene, 2.5 parts by weight of acrylonitrile and 2.5 parts by weight of N-methylacrylamide, having a glass transition temperature of 17° C.

Polymer P1 was used in the form of a 50% by weight aqueous polymer dispersion stabilized with 1% by weight of the ethoxylated C₁₃ fatty alcohol (EO8) and 1.5% by weight of the sodium salt of a sulfuric monoester of ethoxylated C₁₂ alcohol (EO3). The polymer dispersion had a minimum film formation temperature of 16° C.

Addition polymer P2

Copolymer of 54 parts by weight of styrene and 46 parts by weight of 2-ethylhexyl acrylate and also 2.6 parts by weight of acrylic acid, 1 part by weight of acrylamide and 0.5 part by weight of methacrylamide, having a glass transition temperature of 12° C., in the form of a 50% by weight aqueous polymer dispersion having a minimum film formation temperature of 20° C. For its stabilization, the dispersion contains 0.4% by weight of nonylphenol ethoxylate (degree of ethoxylation 25) and 1.2% by weight of the sodium salt of the nonylphenol ethoxylate sulfuric monoester (degree of ethoxylation 25).

Addition polymer P3

Copolymer of 62 parts by weight of styrene and 34 parts by weight of n-butyl acrylate and also 1.5 parts by weight of acrylic acid and 2.5 parts by weight of N-methylolmethacrylamide, having a glass transition temperature of 34° C., in the form of a 50% by weight aqueous polymer dispersion having a minimum film formation temperature of 30° C.

### EXAMPLE B1

8 parts by weight of the polymer powder prepared as described above were added to 100 parts by weight of sand with a particle size in the range up to 2 mm and with a water content of about 7% by weight, and the components were mixed thoroughly in a blender mixing apparatus. The mixture was subsequently compacted to form a sample body, which was dried at room temperature (25° C.) for 36 hours.

### EXAMPLE B2

8 parts by weight of the polymer powder prepared as described above were added to 100 parts by weight of gravel with a particle size in the range of up to 50 mm and with a water content of about 7% by weight, and the components were mixed thoroughly in a blender mixing apparatus. The mixture was subsequently compacted to form a sample body, which was dried at room temperature (25° C.) for 36 hours.

### COMPARATIVE EXAMPLE VB1

100 parts by weight of sand with a particle size in the range up to 2 mm and with a water content of about 7% by weight were compacted to form a sample body, without the addition of a polymer, and dried at room temperature (25° C.) for 36 hours.

### Comparative Example VB2

100 parts by weight of gravel with a particle size in the range up to 50 mm and with a water content of about 7% by weight were compacted to form a sample body, without the addition of a polymer, and dried at room temperature (25° C.) for 36 hours.

The shaped bodies were tested for their dimensional stability both directly after drying and after 24-hour storage in water.

Whereas the sample bodies of the invention from examples B1 and B2 were dimensionally stable both before and after water storage, it was not possible to handle the sample bodies from comparative examples VB1 und VB2 without destruction, either before or after water storage.

We claim:

1. An earth building material comprising
a) a principal, mineral component based on sand, chippings and/or gravel and
b) at least one film-forming water-insoluble addition polymer having a glass transition temperature below 30° C. which is uniformly distributed in the principal, mineral component in an amount of at least 2 parts by weight, based on 100 parts by weight of mineral components, and
c) if desired, up to 2 parts by weight of cement.

2. An earth building material as claimed in claim 1, wherein the addition polymer is used in the form of a redispersible polymer powder.

3. An earth building material as claimed in either of the preceding claims, containing from 3 to 30 parts by weight of addition polymer per 100 parts by weight of mineral components.

4. An earth building material as claimed in any of the preceding claims, wherein the addition polymer has a glass transition temperature in the range from −20 to +25° C.

5. An earth building material as claimed in any of the preceding claims, wherein the addition polymer contains in copolymerized form at least 80% by weight of monomers having a water solubility below 60 g/l (25° C. and 1 bar).

6. An earth building material as claimed in any of the preceding claims, wherein the addition polymer is selected from (meth)acrylate polymers, styrene-(meth)acrylate copolymers, styrene-butadiene copolymers, and ethylene-vinyl acetate copolymers.

7. An earth building material as claimed in any of the preceding claims, comprising the addition polymer in the form of a powder obtainable by a free-radical aqueous emulsion polymerization and, if desired, subsequent drying to a polymer powder.

8. An earth building material as claimed in any of the preceding claims, comprising
a) a principal, mineral component comprising
from 50 to 99 parts by weight of sand, chipping and/or gravel,
from 0 to 20 parts by weight of cement, clay, loam and/or lime,
from 0 to 30 parts by weight of other natural organic and/or mineral earth components,
b) from 3 to 50 parts by weight, based on 100 parts by weight of mineral components, of at least one water-insoluble addition polymer,
c) from 0 to 30 parts by weight, based on 100 parts by weight of mineral components, of water.

9. A process for preparing earth building materials as claimed in any of claims 1 to 8, wherein
i) the principal, mineral constituent,
ii) at least one water-insoluble, film-forming addition polymer, and
iii) if desired, water and further components are mixed to a plastically deformable, flowable or free-flowing composition in which the addition polymer is present in uniform distribution.

10. A method of consolidating soils, in which the soil is excavated, reduced in size if appropriate, at least one film-forming, water-insoluble addition polymer having a glass transition temperature below 30° C. is added in an amount of at least 2% by weight, based on 100% by weight of mineral components, and is mixed in until the polymer is uniformly distributed in the excavated material, mixing being accompanied if appropriate by adjustment of the water content of the mixture to a level in the range from 1 to 30% by weight, and the mixture is reapplied.

11. The use of earth building materials as defined in any of claims 1 to 8 for constructional building operations on the basis of sand, gravel, chippings or mixtures thereof.
